(19) United States
(12) Patent Application Publication
(10) Pub. No.: US 2026/0160639 A1
(43) Pub. Date: Jun. 11, 2026

(54) OPTICAL PROBE, OPTICAL PROBE ARRAY, AND PROBE SYSTEM

(71) Applicant: Kabushiki Kaisha Nihon Micronics, Tokyo (JP)

(72) Inventor: Michitaka OKUTA, Kanagawa (JP)

(21) Appl. No.: 19/181,005

(22) Filed: Apr. 16, 2025

(30) Foreign Application Priority Data
May 20, 2024 (JP) 2024-081889

(51) Int. Cl. G01M 11/00

(52) U.S. Cl. CPC G01M 11/31

(57) ABSTRACT

An optical probe for transmitting an optical signal to, and receiving an optical signal from, an optical device, includes: a tip surface that is a convex curved surface and faces the optical device; an optical waveguide that is a refractive index distribution type and has a first end part connected to the tip surface; and a base end surface to which a second end part of the optical waveguide is connected.

### CROSS-REFERENCE TO RELATED APPLICATIONS

The present application is based on, and claims priority from Japanese Patent Application No. 2024-081889, filed on May 20, 2024, the entire contents of which are incorporated herein by reference.

### TECHNICAL FIELD

The present disclosure relates to an optical probe, an optical probe array, and a probe system for use in measuring optical devices.

### BACKGROUND

A silicon device through which optical signals propagate (hereinafter, also referred to as “optical device”) is formed on a semiconductor wafer using a silicon photonics technique. An optical probe and an electric probe are used to measure properties of the optical device formed on the semiconductor wafer. Thereamong, in measurement using the optical probe, the optical device and the optical probe are aligned in order to reduce loss of optical signals (hereinafter, also referred to as “propagating optical signals”) propagating through an optical waveguide of the optical probe.

### SUMMARY

When an optical transmission path of the optical probe through which propagating optical signals pass is a single mode, a numerical aperture in the optical transmission path is small. Furthermore, since the size of an optical signal terminal where optical signals of the optical device enter and exit is small, only a few micrometers, tolerance of errors in the alignment between the optical signal terminal of the optical device and a tip surface of the optical probe is low. Thus, it is difficult to accurately align the optical device and the optical probe. For example, after coarse positioning where the optical device and the optical probe are made to face each other, precise positioning is performed using an actuator capable of 6-axis degree of freedom adjustments with respect to both linear and rotational positioning for X, Y, and Z axes. Consequently, in the measurement of the optical device, measurement time increases due to the time required for alignment, and connection loss increases and fluctuates due to inaccurate alignment.

In view of the above issues, an object of the present disclosure is to provide an optical probe, an optical probe array, and a probe system that are capable of controlling the time required for alignment with an optical device and controlling connection loss increases and fluctuations.

An optical probe according to an embodiment includes a tip surface that is a convex curved surface and faces an optical device; an optical waveguide that is a refractive index distribution type and has a first end part connected to the tip surface; and a base end surface to which a second end part of the optical waveguide is connected.

In the embodiment, it is possible to provide an optical probe, an optical probe array and a probe system that are capable of controlling the time required for alignment with an optical device, and controlling connection loss increases.

### BRIEF DESCRIPTION OF THE DRAWINGS

FIG. 1 is a schematic diagram illustrating a configuration of an optical probe according to an embodiment.

FIG. 2 is a graph illustrating a mode field pattern shape of the optical probe according to the embodiment.

FIG. 3 is a schematic diagram illustrating another example of the optical probe according to the embodiment.

FIG. 4A is a graph illustrating a relationship between a numerical aperture and a beam diameter of a propagating optical signal.

FIG. 4B is a graph illustrating a relationship between the numerical aperture and a refractive index distribution coefficient.

FIG. 5 is a graph illustrating a relationship between: the ratio of a mode field diameter of an optical signal to a mode field diameter of the optical probe according to the embodiment; and loss.

FIG. 6 is a table illustrating conditions for reducing the amplitude of optical signals propagating in the optical probe according to the embodiment.

FIG. 7A is a graph illustrating ray tracing of an optical signal propagating in an optical waveguide of the optical probe according to the embodiment (part 1).

FIG. 7B is a graph illustrating ray tracing of the optical signal propagating in the optical waveguide of the optical probe according to the embodiment (part 2).

FIG. 7C is a graph illustrating ray tracing of the optical signal propagating in the optical waveguide of the optical probe according to the embodiment (part 3).

FIG. 7D is a graph illustrating ray tracing of the optical signal propagating in the optical waveguide of the optical probe according to the embodiment (part 4).

FIG. 8A is a graph illustrating ray tracing of the optical signal propagating in the optical waveguide of the optical probe according to the embodiment (part 5).

FIG. 8B is a graph illustrating ray tracing of the optical signal propagating in the optical waveguide of the optical probe according to the embodiment (part 6).

FIG. 8C is a graph illustrating ray tracing of the optical signal propagating in the optical waveguide of the optical probe according to an embodiment (part 7).

FIG. 8D is a graph illustrating ray tracing of the optical signal propagating in the optical waveguide of the optical probe according to the embodiment (part 8).

FIG. 9 is a schematic diagram illustrating a configuration of an optical probe according to a first modified example of the embodiment.

FIG. 10 is a schematic diagram illustrating a configuration of an optical probe according to a second modified example of an embodiment.

FIG. 11A is a schematic diagram illustrating a configuration of a probe system using the optical probe according to the embodiment.

FIG. 11B is a schematic plan view illustrating a configuration of the probe system using the optical probe according to the embodiment.

### DETAILED DESCRIPTION

Next, an embodiment of the present application will be described with reference to the drawings. In the description of the following drawings, the same or similar portions are denoted by the same or similar reference numerals. However, it should be noted that the drawings are schematic. Furthermore, the following embodiment illustrates a device and a method for embodying the technical concept of the present application, and the embodiment of the present application does not limit the structure, arrangement, and the like of the components as follows. Various modifications can be made to the embodiment of the present application within the scope of the claims.

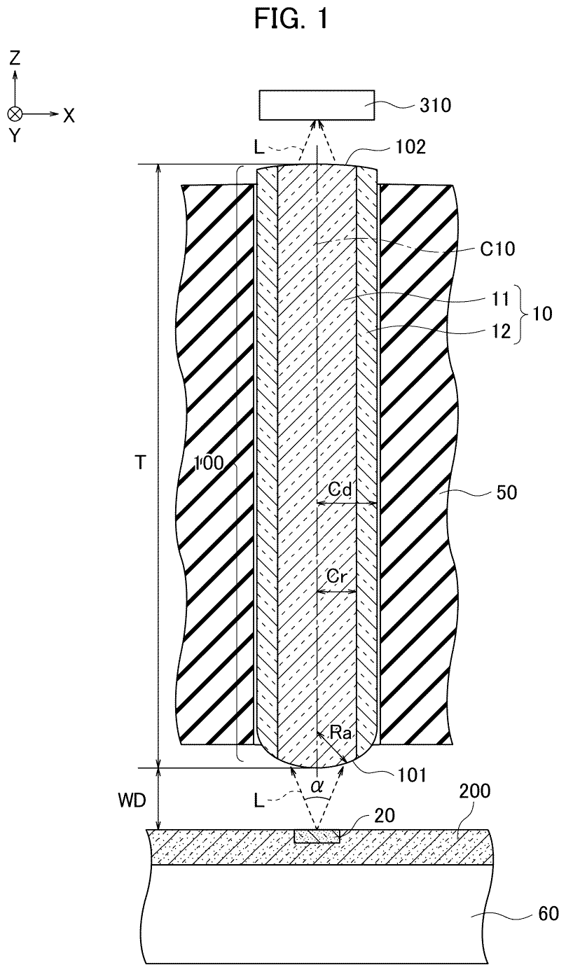

An optical probe 10 according to an embodiment as illustrated in FIG. 1 transmits and receives optical signals to and from an optical device 20 formed on a semiconductor wafer 200. FIG. 1 illustrates a case where an optical signal L that has been emitted from the optical device 20 and has entered the optical probe 10 propagates through an optical waveguide 100 of the optical probe 10. The optical probe 10 includes: a tip surface 101 that is a convex curved surface and faces the optical device 20; the optical waveguide 100, which is a refractive index distribution type and has a first end part connected to the tip surface 101; and a base end surface 102 to which a second end part of the optical waveguide 100 is connected.

As illustrated in FIG. 1, a central axis C10 of the optical waveguide 100 of the optical probe 10 is defined as a Z-axis direction, and a plane perpendicular to the Z-axis direction is defined as an XY plane. The central axis C10 is an optical axis of the optical probe 10. In FIG. 1, the left-right direction in the drawing is defined as an X-axis direction, and a direction perpendicular to the drawing is defined as a Y-axis direction. Hereinafter, the X-axis direction, the Y-axis direction, and the Z-axis direction are collectively referred to as “XYZ-axis directions”.

The optical probe 10 can adopt an optical fiber, or a combination of an optical fiber and a lens. The optical waveguide 100 includes a core portion 11 and a cladding portion 12 arranged on the outer periphery of the core portion 11. The optical waveguide 100 is designed in such a manner that a refractive index of the core portion 11 gradually decreases outward from the optical axis, which is the central axis of the optical waveguide 100. In other words, the refractive index of the core portion 11 gradually decreases outward from the optical axis of the optical probe 10 toward a region adjacent to the cladding portion 12. The shape of a cross section (hereinafter, referred to as “cross-sectional shape”) of the optical probe 10 along the XY plane may be circular or rectangular.

Hereinafter, the length from the tip surface 101 to the base end surface 102 of the optical waveguide 100 of the optical probe 10 is also referred to as “optical path length”. The optical path length of the optical probe 10 as illustrated in FIG. 1 is “T”.

As illustrated in FIG. 1, the inner diameter of the core portion 11 of the optical probe 10 is 2×Cr, and the inner diameter of the optical probe 10 including the cladding portion 12 is 2×Cd. When the cross-sectional shape of the core portion 11 is circular, the radius of the core portion 11 is Cr, and the radius of the optical probe 10 is Cd. When the cross-sectional shape of the core portion 11 is rectangular, the size of the cross-sectional shape of the core portion 11 in the X and Y directions is 2×Cr, and the size of the cross-sectional shape of the optical probe 10 in the X and Y directions is 2×Cd. Hereinafter, a half of the inner diameter of the core portion 11 is referred to as a core radius Cr, and a half of the inner diameter of the cladding portion 12 is referred to as a cladding radius Cd. The core radius Cr is the length from the central axis C10 of the optical waveguide 100 to a boundary between the core portion 11 and the cladding portion 12. The cladding radius Cd is the length from the central axis C10 to an outer edge of the optical probe 10.

For example, as illustrated in FIG. 1, the optical probe 10 is held by a support 50 in such a manner that the central axis C10 is linear. In other words, the optical waveguide 100 is linear from the tip surface 101 to the base end surface 102. Since the optical waveguide 100 is linear, there is no optical path difference in propagating optical signals which propagate through the optical waveguide 100, and occurrence of multi-mode can be controlled.

For example, when the optical probe 10 is an optical fiber, the optical fiber is held by the support 50 so as not to be curved. For example, the support 50 may have a through hole formed on a substrate made from a dielectric material, such as ceramic or plastic, and support the optical probe 10 in a state of passing through the through hole. Alternatively, the support 50 may have a structure of stacked thin plates which are made from a dielectric material, and have a circular or rectangular through hole through which the optical probe 10 passes. The support 50 may have a structure having a V-groove or a U-groove formed on a substrate, and fix the optical probe 1. As described above, various methods can be employed for supporting the optical probe 10.

The optical probe 10 is held in such a manner that the tip surface 101 faces the optical device 20 formed on the semiconductor wafer 200 placed on a stage 60. The semiconductor wafer 200 is held on the stage 60 through vacuum adsorption, for example.

The optical device 20 is a silicon photonics device where an optical circuit and an electronic circuit are integrated, and thus an increase of operating speed of the circuit, improvement of functions, and reduction of power consumption can be expected considering the optical circuit's insensitivity to electromagnetic induced noise. Many silicon photonics devices can be formed on a composite stacked substrate, such as an SOI (silicon on insulator) substrate using silicon and quartz, by means of semiconductor microfabrication technology, such as a CMOS integrated circuit. For optical measurement of the optical device 20 formed on the semiconductor wafer 200, an optical signal terminal including a diffraction grating at a silicon waveguide end of the optical device 20 may be arranged on the upper surface of the semiconductor wafer 200 and used as an input/output terminal for measurement. By arranging a diffraction grating at the optical signal terminal of the optical device 20, the optical signal L emitted from the optical signal terminal of the optical device 20 travels in the Z-axis direction as illustrated in FIG. 1.

The tip surface 101 of the optical probe 10 is optically connected to the optical signal terminal of the optical device 20, which emits the optical signal L having a radiation angle α. The tip surface 101 is a convex curved surface having a radius of curvature Ra. Details of the radius of curvature Ra will be described below. The optical signal L emitted from the optical device 20 enters the tip surface 101 of the optical probe 10.

The optical probe 10 is arranged away from the optical device 20 by a working distance WD along the Z-axis direction. The working distance WD is set to a range where the optical probe 10 can receive the optical signal L emitted from the optical device 20. In other words, the working distance WD is set in such a manner that an incident range of the optical signal L at the tip surface 101 is inside the core portion 11.

The base end surface 102 of the optical probe 10 is optically connected to a light receiving element 310. That is, the optical signal L emitted from the optical device 20 propagates through the optical waveguide 100 of the optical probe 10, is emitted from the base end surface 102, enters on the light receiving element 310, and is subject to photoelectric conversion. The light receiving element 310 is electrically connected to a measuring device, not illustrated, and properties of the optical signal L are measured using the measuring device.

As described above, the core portion 11 has the refractive index distribution type structure. That is, the refractive index of the core portion 11 decreases gradually in a radial direction toward the cladding portion 12, from the refractive index at the optical axis, which is the central axis C10 (hereinafter, referred to as “optical axis refractive index”). That is, the refractive index in a region adjacent to the cladding portion 12 of the core portion 11 (hereinafter, referred to as “outer edge refractive index”) is a minimum. Using an optical axis refractive index n0 and an outer edge refractive index n1, a refractive index distribution N (x) of the core portion 11 at a distance “x” in the X direction from the optical axis is expressed by parabolic equation (1) below:

$$N ( x ) = n 0 \times \{ 1 - {( {A}^{1 / 2} \times x )}^{2} / 2 \} \qquad ( 1 )$$

In equation (1), A^{1/2} is a refractive index distribution coefficient, expressed by equation (2):

$${{A}^{1 / 2} = ( ( n {0}^{2} - n {1}^{2} ) / {( n 0 \times Cr )}^{2} \}}^{1 / 2} \qquad ( 2 )$$

The larger the difference (n0−n1) between the optical axis refractive index n0 and the outer edge refractive index n1, the larger the refractive index distribution coefficient A^{1/2}, and the more the confinement of the propagating optical signal in the optical waveguide 100. “Confinement” means that the propagating optical signal propagates inside the core portion 11 and is not radiated to the cladding portion 12. Note that the larger the refractive index distribution coefficient A^{1/2}, the smaller the amplitude of the propagating optical signal propagating through the optical waveguide 100.

In contrast, when the optical axis refractive index n0, the outer edge refractive index n1, and the refractive index distribution coefficient A^{1/2} are set, the core radius Cr of the optical waveguide 100 can be set as shown in equation (3):

$$Cr = {\{ ( n {0}^{2} - n {1}^{2} ) / {( {A}^{1 / 2} \times n 0 )}^{2} \}}^{1 / 2} \qquad ( 3 )$$

By increasing the confinement, optical connection between the optical probe 10 and the optical device 20 can be stabilized even if a fluctuation, such as positional deviation in the XY direction or positional deviation of the beam diameter (hereinafter, also referred to as “positional fluctuation”), occurs with respect to the optical axis, between the optical probe 10 and the optical device 20. For example, according to a study by the inventors, the refractive index distribution coefficient A^{1/2} of the optical waveguide 100 is preferably 0.004 or more.

An optical path length T of the optical waveguide 100 is expressed by equation (4) as below:

$$T = 2 π \times P / {A}^{1 / 2} \qquad ( 4 )$$

In equation (4), P is called a pitch length, which corresponds to one period (2π) of the propagating optical signal and is an optional value larger than 0.

If P=1, T=2π/A^{1/2}, which is a waveform length corresponding to one period of the propagating optical signal. In the optical probe 10, the radius of curvature Ra of the tip surface 101 may be set to satisfy a relation Cr≥Ra. The smaller the radius of curvature Ra of the tip surface 101, the smaller the amplitude of the propagating optical signal in the optical waveguide 100 can be.

Since the tip surface 101 is a convex curved surface, the optical signal L entering the tip surface 101 is refracted with respect to the optical axis. Thus, the amplitude of the propagating optical signal decreases within the optical waveguide 100. Thereby, there is a spatial allowance of a size (2×Cr) on the XY plane of the core portion 11 for the propagation path of the propagating optical signal. Consequently, even if the position of the optical device 20 deviates from the optical axis of the optical probe 10 in the XY direction, the propagating optical signal propagates through the core portion 11 without being radiated to the cladding portion 12. The propagating optical signal propagating through the core portion 11 stably enters the light receiving element 310 via the base end surface 102 of the optical probe 10.

The radiation angle α of the optical signal L emitted from the optical signal terminal of the optical device 20 is defined by a beam diameter ωg of the optical signal L. The relationship between the beam diameter ωg and the radiation angle α is approximately represented by equation (5):

$$α / 2 = {tan}^{- 1} \{ λ / ( π \cdot ω g ) \} \qquad ( 5 )$$

In equation (5), λ is the wavelength of the optical signal L. The numerical aperture NA of the optical probe 10 is NA=sin (α/2).

Equation (6) below can be approximated from FIG. 1:

$$α / 2 = {tan}^{- 1} ( Cr / WD ) \qquad ( 6 )$$

The numerical aperture NA and the beam diameter ω have a relationship where the larger the numerical aperture NA, the smaller the beam diameter ω. The range of the effective working distance WD, where the optical probe 10 can receive the optical signal L, is expressed by equation (7):

$$Cr / tan \{ {sin}^{- 1} ( NA ) \} \geq WD > 0 \qquad ( 7 )$$

If the working distance WD satisfies the condition of equation (7), all of the optical signal L from the optical device 20 can be made enter the optical waveguide 100 from the tip surface 101.

If a beam diameter formed by the tip surface 101 having the radius of curvature Ra is ωa, and a beam diameter of the optical signal L is ωg, the radius of curvature Ra is set to satisfy a relationship in equation (8):

$$ω a > ω g \qquad ( 8 )$$

For example, if a wavelength λ of the optical signal L is 1.55 μm, and the beam diameter ωg is 2 μm, the numerical aperture NA of the optical device 20 is 0.24. In this case, the tip surface 101 of the optical probe 10 may be subject to spherical processing with respect to the radius of curvature Ra in such a manner that the numerical aperture NA of the tip surface 101 is less than 0.24. If the core radius Cr is 32.5 μm, the condition of the working distance WD is 130 μm or less.

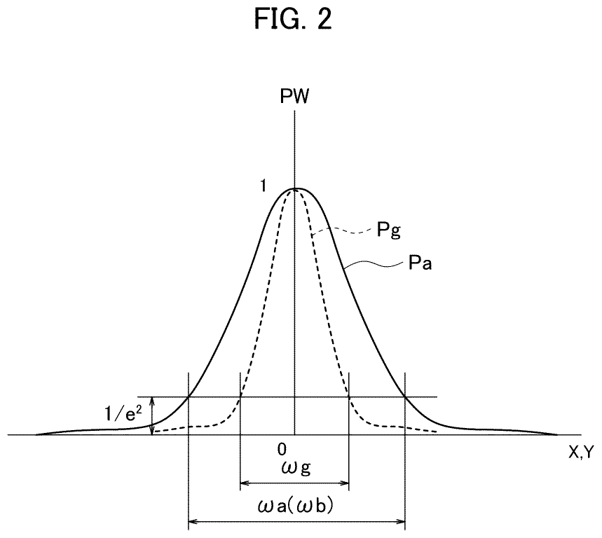

FIG. 2 illustrates a relationship between a mode field pattern Pa of incident light of the optical probe 10 and a mode field pattern Pg of the optical signal L when the above conditions are satisfied. When the tip surface 101 is curved, a mode field pattern is formed that exhibits a wide beam intensity PW distribution having a flat peak. As illustrated in FIG. 2, the mode field pattern Pa has a larger mode field diameter and a wider beam diameter than the mode field pattern Pg. Thus, even if a positional fluctuation occurs between the optical probe 10 and the optical device 20, thereby causing deviation, an overlapping portion of the mode field pattern does not change. Thus, no fluctuation in the connection strength occurs between the optical device 20 and the optical probe 10. That is, even if a positional fluctuation occurs, loss of the propagating optical signal is controlled. Note that the mode field pattern Pa depends on the numerical aperture NA (=sin(α/2)) related to the radius of curvature R of the tip surface 101 of the optical probe 10.

The above description is a case where the optical signal L emitted from the optical device 20 travels in a direction normal to the upper surface of the semiconductor wafer 200, and the central axis C10 of the optical probe 10 is in the normal direction. However, a direction where the optical signal L travels may cross the normal direction. For example, when the angle formed between the direction where the optical signal L travels and the normal direction of the semiconductor wafer 200 is an angle θ, the central axis C10 of the optical probe 10 only needs to be installed at the angle θ in the same direction as the direction where the optical signal L travels.

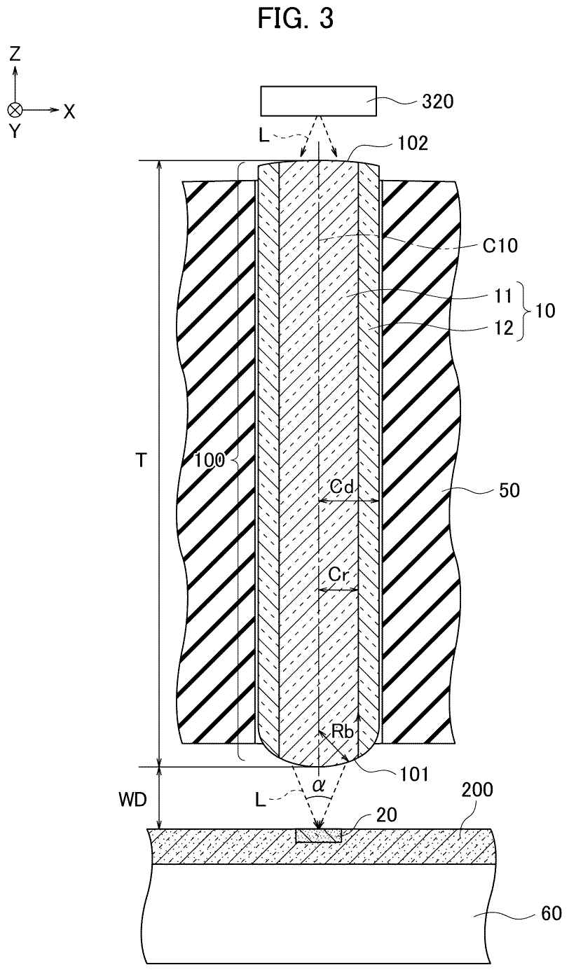

FIG. 3 illustrates a case where the optical signal L emitted from a light emitting element 320 is made to enter the optical signal terminal of the optical device 20 via the optical probe 10. The light emitting element 320 is, for example, a semiconductor laser element. The optical signal L emitted from the semiconductor laser element having a numerical aperture NAr enters the base end surface 102 of the optical probe 10, propagates through the optical waveguide 100, and is emitted from the tip surface 101. In FIG. 3, the optical probe 10 including the tip surface 101 having the radius of curvature Rb is used, and the optical signal L having the radiation angle α is emitted from the tip surface 101.

In this case, the relationship between the beam diameter ωb formed by the tip surface 101 having the radius of curvature Rb, and the beam diameter ωg of the optical device 20 is set to NAr<NAg under the same conditions as in FIG. 1, and the radius of curvature Rb is set to satisfy a relationship in equation (9):

$$ω b > ω g \qquad ( 9 )$$

In equation (9), the beam diameter of the optical signal L received by the optical device 20 is ωg, and the numerical aperture for realizing it is NAg.

By satisfying equation (9), the relationship between the beam diameter ωg and the beam diameter ωb is similar to the relationship between the beam diameter ωg and the beam diameter ωa as illustrated in FIG. 2. Thus, even if positional deviation occurs in the XY direction with respect to the optical axis of the optical probe 10, the intensity fluctuation of light entering the optical device 20 is controlled.

In the above description, the radius of curvature of the tip surface 101 when the optical signal L emitted from the optical device 20 enters is Ra, and the radius of curvature of the tip surface 101 when the optical signal L emitted from the tip surface 101 enters the optical device 20 is Rb. The values of the radius of curvature Ra and the radius of curvature Rb may be the same or different. For example, the radius of curvature Rb may be made smaller than the radius of curvature Ra. Thus, the optical signal L can be made to surely enter a diffraction grating having a smaller size. Hereinafter, the radius of curvature Ra and the radius of curvature Rb are collectively referred to as “radius of curvature R”. Similarly, the beam diameter ωa formed by the tip surface 101 of the radius of curvature Ra, and the beam diameter ωb formed by the tip surface 101 of the radius of curvature Rb, may be the same or different. Hereinafter, the beam diameter ωa and the beam diameter ωb are collectively referred to as “beam diameter ω”.

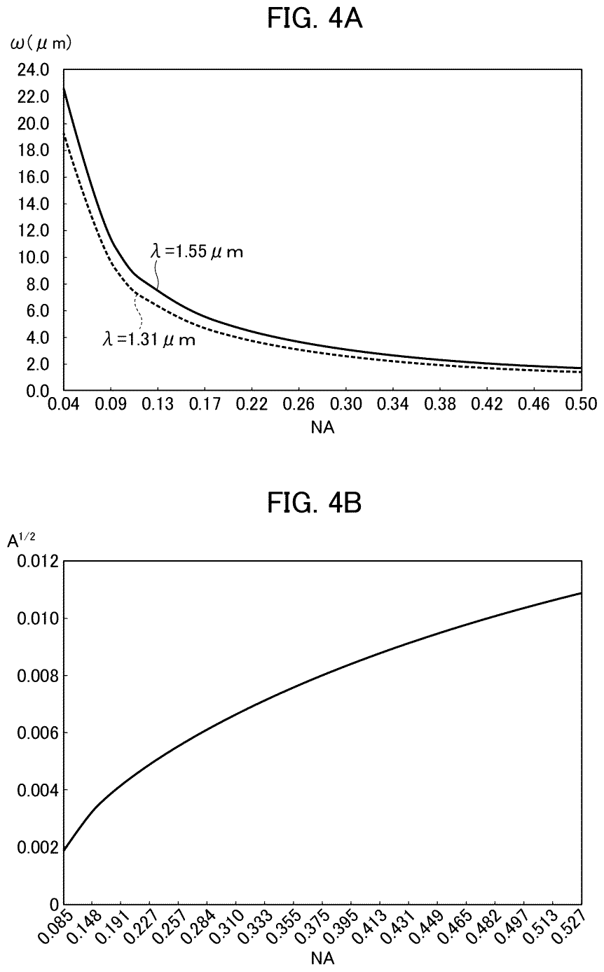

FIGS. 4A and 4B are graphs illustrating basic properties of the optical waveguide 100 of the optical probe 10. FIG. 4A is a graph illustrating a relationship between the numerical aperture NA and the beam diameter ω of propagating optical signals. The larger the numerical aperture NA, the narrower the beam diameter ω. For example, when the wavelength λ of a propagating optical signal is 1.55 μm, and the numerical aperture NA is 0.24, the beam diameters ω is 2 μm. When the beam diameter of the optical signal L of the optical device 20 is ωg, and the numerical aperture for realizing it is NAg, the radius of curvature R is set in such a manner that NAg>NAa, where the beam diameter of the propagating optical signal of the optical probe 10 is ωa, and the numerical aperture is NAa.

Meanwhile, the beam diameter ωg of the optical signal L can have an asymmetric shape in a first direction (e.g., X direction) and a second direction (e.g., Y direction) perpendicular to the first direction, in the XY plane perpendicular to the normal direction of the vertex of the tip surface 101, depending on the shape of the optical device 20. For example, when the beam diameters in the first direction and the second direction are a first beam diameter ωg1 and a second beam diameter ωg2, respectively, the values of the first beam diameter ωg1 and the second beam diameter ωg2 are different. In this case, by also setting the mode field diameter of the optical probe 10 asymmetric in the first direction and the second direction, the connection efficiency between the optical device 20 and the optical probe 10 is improved, and measured properties are stabilized. For example, when the radius of curvature in the first direction of the tip surface 101 of the optical probe 10 is a first radius of curvature R1, and the radius of curvature in the second direction is a second radius of curvature R2, the first radius of curvature R1 and the second radius of curvature R2 are set to different values. Here, the difference between the first radius of curvature R1 and the second radius of curvature R2 is made correspond to the difference between the first beam diameter ωg1 and the second beam diameter ωg2. As described above, the first radius of curvature R1 in the first direction (e.g., the X direction), and the second radius of curvature R2 in the second direction perpendicular to the first direction (e.g., the Y direction) may be different.

FIG. 4B is a graph illustrating a relationship between the numerical aperture NA of the optical waveguide 100 of the optical probe 10, and the refractive index distribution coefficient A^{1/2}. The value of the optical axis refractive index n0 changes within a range of 1.44 to 1.55. As the optical axis refractive index n0 increases, the refractive index distribution coefficient A^{1/2} increases. For example, when the numerical aperture NA is near 0.28, the refractive index distribution coefficient A^{1/2} is 0.006. Using the optical waveguide 100 having the above parameters, the numerical aperture NAg of the optical device 20 satisfies a condition of NAg≥NA.

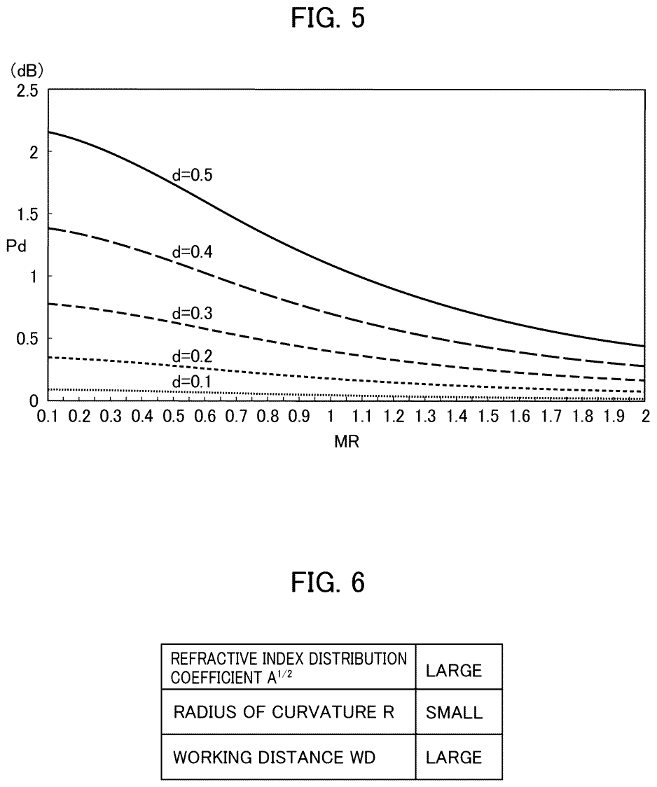

FIG. 5 is a graph illustrating a relationship between a ratio of the mode field diameter of the optical signal L to the mode field diameter of the optical probe 10 (MFD ratio MR) and loss. FIG. 5 illustrates a loss Pd with MR=ωa/ωg as the horizontal axis, and with a deviation d=B/ωa using a positional deviation amount B in the XY direction as a parameter. As illustrated in FIG. 5, when the MFD ratio MR is larger than 1, the loss with respect to the positional deviation amount B in the XY direction is smaller. For example, when MR=1.5 and d=0.2, the loss is as small as about 0.1 dB, and influence by the difference in the mode field diameter is smaller.

FIG. 6 is a table illustrating conditions for reducing the amplitude of a propagating optical signal propagating through the optical probe 10. The propagating optical signal propagates in a sinusoidal shape through the optical waveguide 100 of the refractive index distribution type. Thus, when the amplitude of the propagating optical signal is smaller, it is possible to control the propagating optical signal from being radiated to the cladding portion 12 due to fluctuation of the amplitude of the propagating optical signal caused by the positional deviation amount B, and an angular deviation amount Δ of the optical signal L. The angular deviation amount Δ is the angle formed by the optical axis of the optical signal L and the optical axis of the optical probe 10. As a condition for reducing the amplitude of the propagating optical signal, it is preferable that the refractive index distribution coefficient A^{1/2} of the optical waveguide 100 be larger, and the radius of curvature R of the tip surface 101 of the optical probe 10 be smaller. Also, the larger the working distance WD, the smaller the amplitude of the propagating optical signal. By reducing the amplitude of the propagating optical signal, the optical connection between the optical probe 10 and the optical device 20 can be stabilized even if the positional deviation amount B and the angular deviation amount Δ occur in the XY direction with respect to the optical axis, and the measurement can be performed with stable intensity properties even if the positional fluctuation or the like occurs.

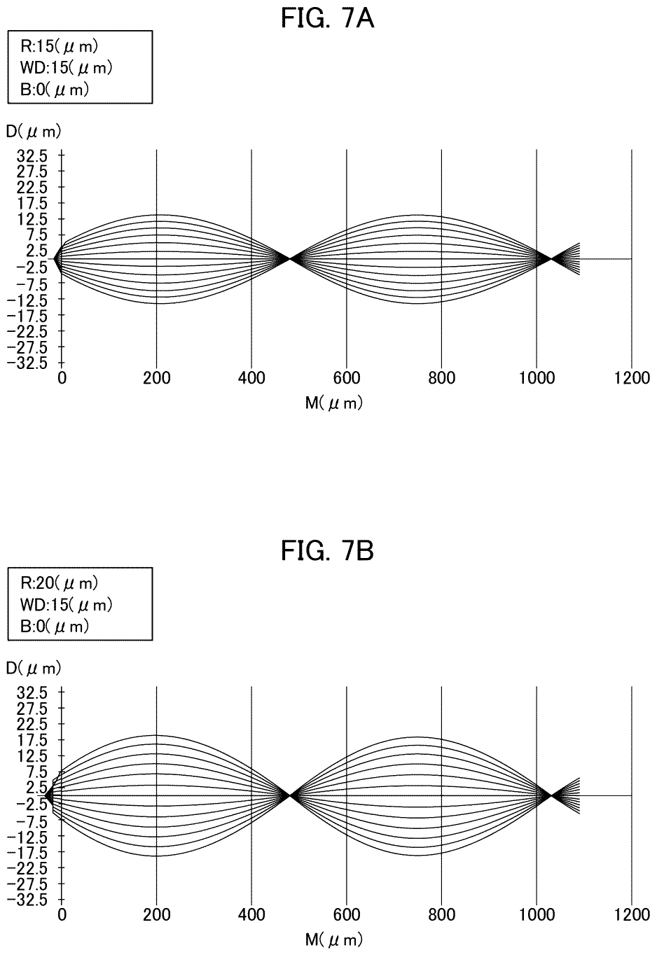

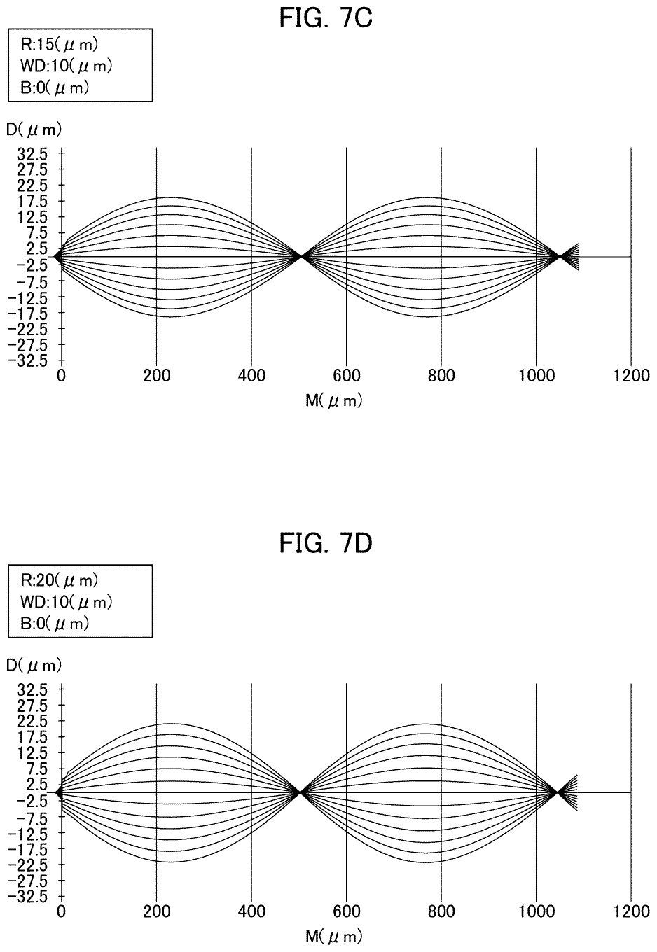

FIGS. 7A to 7D illustrate ray tracing of a propagating optical signal propagating through the optical waveguide 100 of the optical probe 10 for 1 P (one period). Conditions of the optical waveguide 100 are A^{1/2}=0.006, Cr=32.5 μm, and the numerical aperture NA of the optical signal L from the optical device 20 is 0.24. In FIGS. 7A to 7D, the horizontal axis is a position M from the tip surface 101 toward the base end surface 102, and the vertical axis is a distance D in an inner diameter direction from the central axis C10.

FIGS. 7A to 7D compare the state of a propagating optical signal when the radius of curvature Ra of the tip surface 101 of the optical probe 10 is 15 μm or 20 μm, and the working distance WD is 10 μm or 15 μm. Note that this is for cases where the positional deviation amount B=0 μm, and there is no angular deviation amount. As illustrated in FIGS. 7A to 7D, the smaller the radius of curvature Ra of the tip surface 101 of the optical probe 10, the smaller the amplitude of the propagating optical signal, and the longer the working distance WD, the smaller the amplitude of the propagating optical signal.

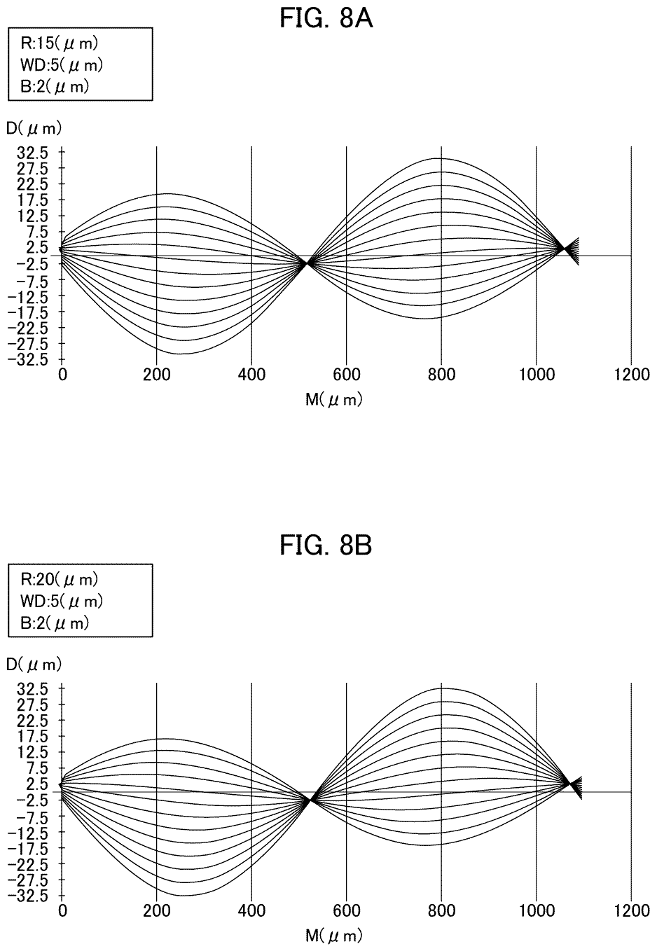

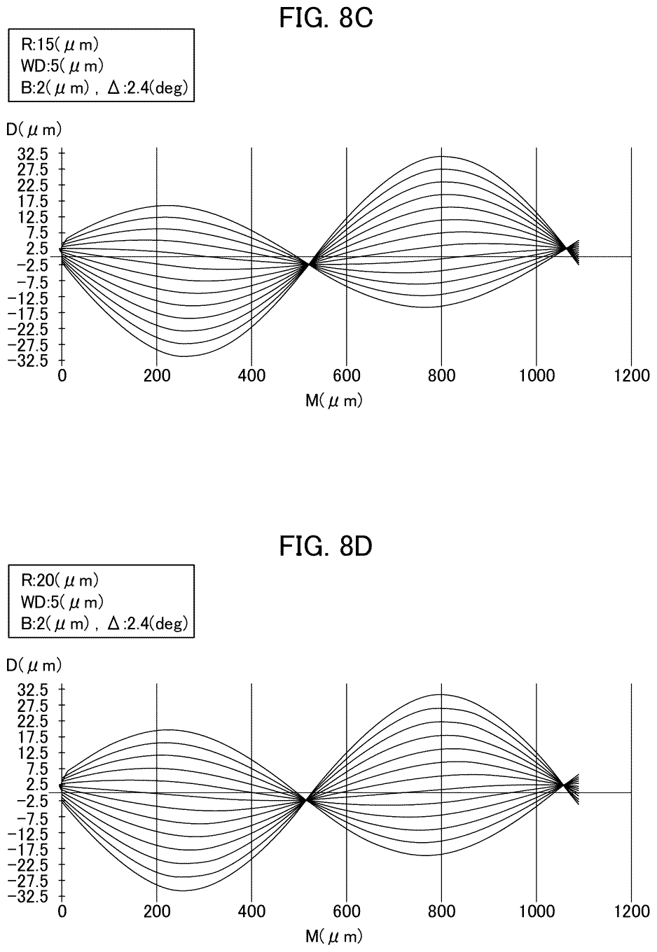

FIGS. 8A to 8D illustrate ray tracing for 1 P (one cycle) of a propagating optical signal propagating through the optical waveguide 100. In FIGS. 8A to 8D, the horizontal axis is the position M from the tip surface 101 toward the base end surface 102, and the vertical axis is the distance D in the inner diameter direction from the central axis C10. FIGS. 8A and 8B illustrate the state of the propagating optical signal for 1 P (one cycle) when the radius of curvature Ra of the tip surface 101 is 15 μm or 20 μm, the working distance WD is 5 μm, and the positional deviation amount B is 2 μm. In both FIGS. 8A and 8B, even if the positional deviation amount B=2 μm, the propagating optical signal is within the core radius Cr and does not easily leak from the optical waveguide 100. In addition, it is estimated that the smaller the radiation angle α of entering and emitted light, the more there is a margin for positional deviation even if the amplitude of the propagating optical signal fluctuates. FIGS. 8C and 8D illustrate ray tracing of the propagating optical signal when the angular deviation amount Δ=2.4 degrees in addition to the positional deviation amount B with respect to the optical axis under the above conditions. In both FIGS. 8C and 8D, the propagating optical signal can propagate within the optical waveguide 100 even though the amplitude fluctuation is observed. In view of the foregoing, it is effective to reduce the radiation angle α of the entering and emitted light in order to provide a margin for the fluctuation of the propagating optical signal. In addition, by increasing the working distance WD, it is possible to provide a margin for the amplitude fluctuation of the propagating optical signal when the positional deviation amount B and the angular deviation amount Δ with respect to the optical axis occur. Consequently, the intensity fluctuation does not easily occur, and the measurement becomes stable.

### Modified Examples

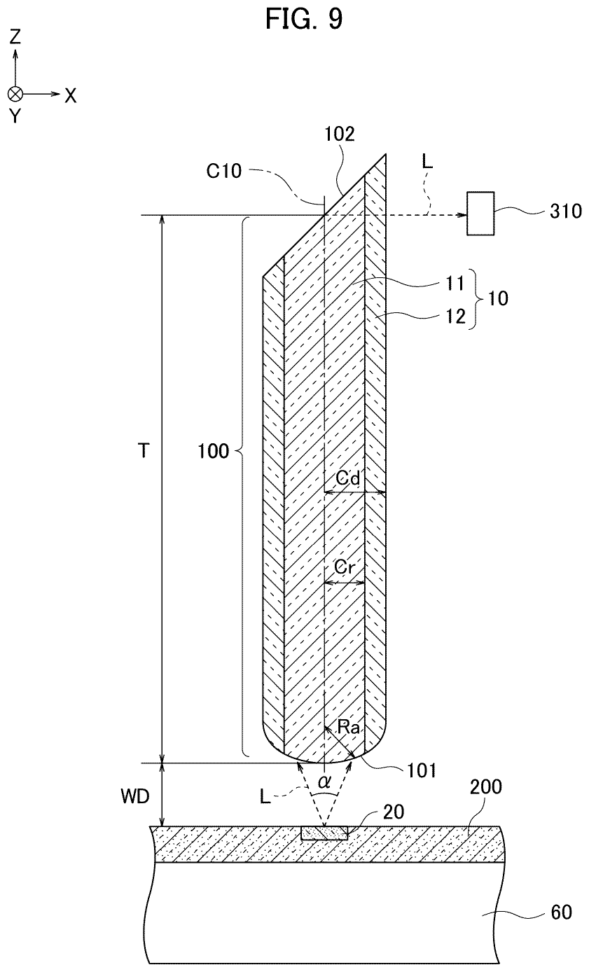

In the optical probe 10 according to a first modified example of the embodiment, as illustrated in FIG. 9, a direction extending to the base end surface 102 of the optical waveguide 100, and the base end surface 102 itself obliquely intersect each other. Thus, the direction where the propagating optical signal travels changes at the boundary between the optical waveguide 100 and the base end surface 102. For example, the base end surface 102 may be oriented at an angle of 45 degrees with respect to the direction along which the optical waveguide extends, and the direction where the propagating optical signal travels changes by 90 degrees. By arranging the light receiving element 310 to intercept the changed direction, where the propagating optical signal travels, the light receiving element 310 receives the optical signal L emitted from the optical device 20. For example, the base end surface 102 may be subject to inclined machining with respect to the central axis C10 through mirror polishing (reflection coating with a positive dielectric multilayer film may be applied). The outside of the base end surface 102 is an air layer.

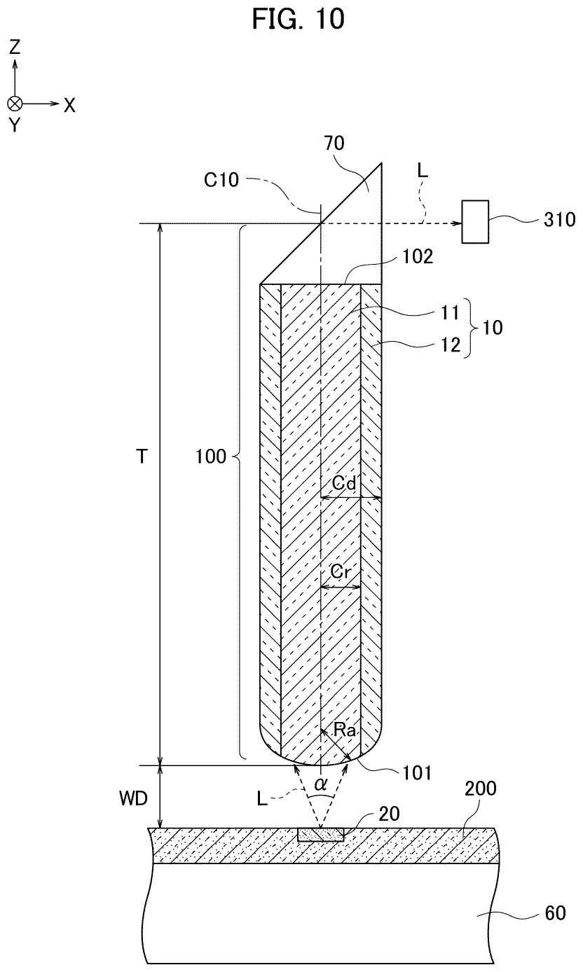

In the optical probe 10 according to a second modified example of the embodiment, as illustrated in FIG. 10, an optical element 70 for changing a direction where the propagating optical signal travels is arranged on the base end surface 102. The optical element 70 is, for example, a microscopic prism body. The optical element 70 changes, for example, the direction where the propagating optical signal travels, by 90 degrees. Similarly as illustrated in FIG. 9, by arranging the light receiving element 310 to intercept the changed direction, where the propagating optical signal travels, the light receiving element 310 receives the optical signal L emitted from the optical device 20.

In the optical probes 10 of modified examples as illustrated in FIGS. 9 and 10, the light receiving element 310 can be installed to intercept the direction intersecting the optical axis of the optical probe 10 (for example, 90 degrees). Alternatively, the light emitting element 320 can be installed to intercept the direction intersecting the optical axis of the optical probe 10. Thus, for example, the light receiving element 310 or the light emitting element 320 can be arranged perpendicular to the optical axis of the optical probe 10. Therefore, it is possible to provide flexibility in mounting by using a probe card that holds the optical probe 10.

As described above, the optical probe 10 according to the embodiment includes the curved tip surface 101 and the optical waveguide 100 of a refractive index distribution type, and thus the intensity fluctuation does not easily occur even if the positional deviation amount B and the angular deviation amount Δ occur in the X-axis direction and Y-axis direction. Therefore, it is not necessary to perform two-step alignment of coarse motion positioning, and precise positioning using an actuator capable of 6-axis degree of freedom adjustments. For example, it is possible to align the optical probe 10 and the optical device 20 only by XYZ-axis positioning and Z-axis rotational adjustment.

In contrast, it is necessary to perform precise alignment in order to use a single-mode fiber with a small numerical aperture NA of about 0.11 to 0.13 as the optical probe to measure the optical device 20 having an entering/emitting mode field diameter size of about several μm of an optical signal terminal. Furthermore, radiation loss of light propagating in a fiber is likely to occur due to micro vibrations and fluctuations, and measurement results are sensitive and unstable, making it difficult to ensure the connection stability. Therefore, it is difficult to stably measure the optical device 20 using a single-mode fiber.

In contrast, in the optical probe 10 according to the embodiment, since the intensity fluctuation is small with respect to the positional deviation amount B and the angular deviation amount Δ, the time required for aligning the optical probe 10 and the optical device 20 can be shortened, and the increase and fluctuation of the connection loss can be controlled.

The radius of curvature R of the tip surface 101 of the optical probe 10 may be, for example, about 5 to 20 μm. By making the tip surface 101 a curved surface, the optical waveguide 100 of the refractive index distribution type has a mode field pattern where a beam intensity distribution has a flat peak and is wide. Therefore, even if the positional fluctuation occurs, such as the occurrence of the positional deviation amount B, the overlapping portion of the mode field of the optical waveguide 100 and the optical signal L does not change. Consequently, a stable connection without intensity fluctuation can be realized.

Moreover, the optical probe 10 has a margin for confinement of optical signals in the Z-axis direction as compared with an optical probe having a single-mode optical waveguide, and a core inner diameter 2Cr can be increased by about 10 times. Therefore, the working distance WD can be widely set.

Furthermore, the numerical aperture of the optical waveguide 100 of the refractive index distribution type of the optical probe 10 is about 0.25 to 0.30, which is larger than the numerical aperture of 0.11 to 0.13 of the single-mode fiber. Therefore, even when the angular deviation amount Δ occurs, the confinement is strong, and by reducing the amplitude of the propagating optical signal propagating through the optical waveguide 100, the radiation loss is controlled, and the intensity fluctuation of the propagating optical signal does not easily occur.

As described above, in the optical probe 10, stable propagation of the propagating optical signal is possible against positional deviation in the XY-axis direction and the Z-axis direction, and angular deviation in the optical axis direction, and the connection property is stabilized. Thus, stable measurement is possible even when the optical probe 10 of a multi-core type is configured for measurement. In addition, by using a probe set where an electric probe for transmitting and receiving electric signals to and from the optical device 20, and the optical probe 10, are formed as one body, it is possible to align the electric probe and the optical probe 10 in one step adjustment by providing elasticity of several tens of μm on the electric probe side when the optical device 20 is connected. Thus, simplification of mechanism of the measurement system and ease of control can be realized, and thus measurement inspection time can be greatly shortened.

An optical probe array may be configured by arranging multiple optical probes 10. By using the optical probe array for measurement of the optical device 20, multiple optical signal terminals can be simultaneously aligned with the optical probes 10. Thus, properties of the optical device 20 can be measured in a short time by using the optical probe array. That is, by performing multiple core connection between the optical probes 10 and the optical signal terminals using the optical probe array, the time required for alignment can be greatly reduced compared with a measurement method where alignment of the optical probe 10 with an optical signal terminal is performed one by one.

When the optical probe array is configured by arranging multiple optical probes 10, an error of about ±several μm may occur in the position of the optical probes 10 arranged in the optical probe array. However, the optical probes 10 have a large tolerance for the positional deviation amount B and the angular deviation amount Δ in the XYZ-axis direction. Thus, the intensity fluctuation can be reduced in the optical probe array configured by the optical probes 10, even if a relative position of the optical probe 10 and the optical device 20 fluctuates, or angular deviation occurs in the angular direction of the optical axis. Therefore, by using the optical probe array configured by the optical probes 10, it is possible to easily align each of the optical signal terminals of the optical devices 20 formed in a large number on the semiconductor wafer 200, and the optical probes 10, with the intensity fluctuation reduced.

That is, in the measurement using the optical probe array configured by the optical probes 10, the measurement time can be shortened, and the connection loss fluctuation can be reduced, by simultaneously aligning and measuring multiple optical devices 20. Consequently, measurement evaluation of the optical devices 20 can be stably and easily performed, and the yield and productivity can be improved.

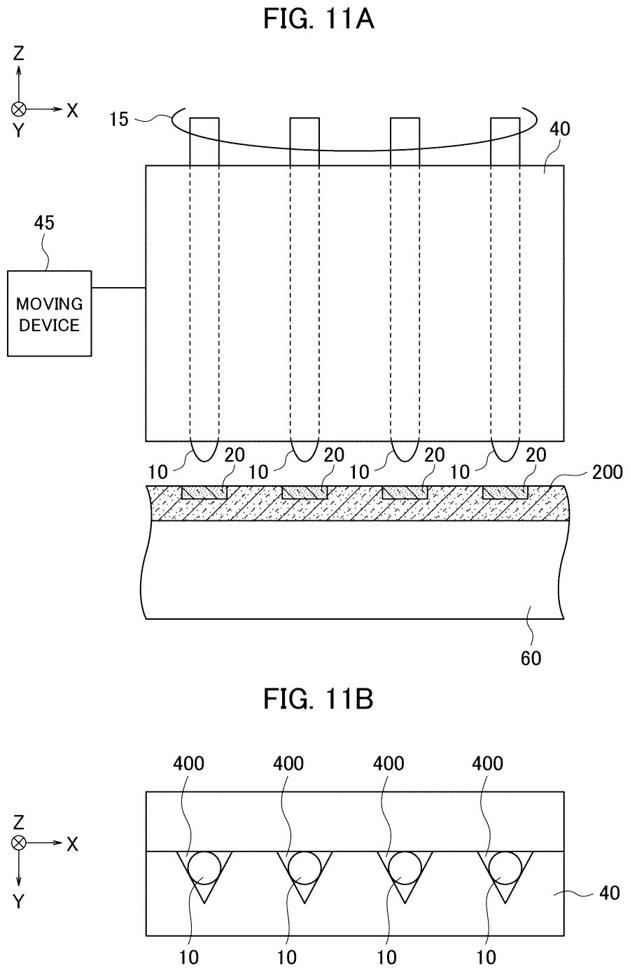

FIGS. 11A and 11B illustrate configuration examples of a probe system 1 using the optical probes 10. As illustrated in FIG. 11A, the probe system 1 includes a probe head 40 as a support for supporting the optical probes 10. The probe head 40 holds an optical probe array 15 where multiple optical probes 10 are arranged in a multi-core array. For example, although not illustrated, optical probes 10 are arranged in the optical probe array 15 at equal intervals along the Y-axis direction as well as the X-axis direction.

In the probe system 1, as illustrated in FIG. 11B, the optical probes 10 are supported by using the probe head 40 made from a dielectric material, where V-shaped grooves 400 are formed in a plan view viewed from the Z-axis direction. The optical probes 10 are fitted and fixed in the V-shaped grooves 400 formed in the probe head 40. As another method, multiple through-holes may be formed in the probe head 40, and the optical probes 10 may be inserted and fixed in the through-holes.

The optical probes 10 held by the probe head 40 are arranged in such a manner that the tip surfaces 101 face positions of optical signal terminals of the multiple optical devices 20 formed in the array on the semiconductor wafer 200. If positional intervals of the optical signal terminals of the optical devices 20 are uniform, measurement of the optical devices 20 using the optical probes 10 becomes smooth and easy.

The probe system 1 includes a moving device 45 capable of precisely positioning the probe head 40 in order to align the tip surfaces 101 of the optical probes 10 with the optical devices 20. The probe head 40 may be moved in each of the X-axis direction, the Y-axis direction, and the Z-axis direction by controlling the moving device 45. Furthermore, the probe head 40 may be moved in a rotational direction about the Z-axis by controlling the moving device 45. Note that the moving device 45 is not necessary when the probe side, to which the semiconductor wafer 200 to be measured is mounted, includes such a positioning mechanism. Thus, it is possible to align the optical probes 10 and the optical devices 20 in the probe system 1. Note that it is also possible to fix the position of the probe head 40 and move the stage 60 in the XYZ-axis direction and the rotational direction of Z axis. Alternatively, the probe head 40 may be moved in the X-axis direction and the Y-axis direction, and the stage 60 may be moved in the Z-axis direction. Thus, various adjustment methods can be adopted for the alignment of the optical probes 10 and the optical devices 20.

Note that the probe system 1 may include electric probes for applying a current or voltage to drive the optical devices 20. In this case, the alignment of the optical probes 10 and the optical devices 20, and the alignment of the electric probes and the optical devices 20 may be performed independently. Alternatively, the optical probes 10 and the electric probes may be integrally configured, and alignment may be performed. Since the optical probes 10 have a large tolerance for the positional deviation amount B and the angular deviation amount Δ, the connection loss can be reduced even in the micron order alignment of the electric probes and the optical devices 20, which does not require high accuracy in the submicron order.

After the alignment of the optical probes 10 and the optical devices 20, optical signals are propagated through the probe system 1 as illustrated in FIG. 11A to measure the optical devices 20. For example, the optical probes 10 receive the optical signals L emitted from the optical devices 20. Alternatively, optical signals emitted from light emitting elements arranged to face the base end surfaces 102 propagate through the optical probes 10, and enter the optical devices 20 on the semiconductor wafer 200.

Note that although FIG. 11 illustrates a configuration where the optical probes 10 are arranged in an array, the optical probe array 15 may have other configurations. For example, the optical probe array 15 may have a configuration where the optical probes 10 are arranged at any positions in the X-axis direction or the Y-axis direction.

### Other Embodiments

Although the present invention has been described in accordance with the embodiment as described above, the descriptions and drawings which form part of this disclosure should not be understood as limiting the invention. Various alternative embodiments, examples, and techniques of operation will be apparent to those skilled in the art from this disclosure. The present invention of course includes various embodiments and the like not described above.

What is claimed is:

1. An optical probe for transmitting an optical signal to, and receiving an optical signal from, an optical device, comprising:
a tip surface that is a convex curved surface and faces the optical device;
an optical waveguide that is a refractive index distribution type and has a first end part connected to the tip surface; and
a base end surface to which a second end part of the optical waveguide is connected.

2. The optical probe according to claim 1, wherein the optical waveguide is linear between the tip surface to the base end surface.

3. The optical probe according to claim 1, wherein
the optical waveguide includes a core portion, and a cladding portion arranged on an outer periphery of the core portion, and
a radius of curvature R of the tip surface, and an inner diameter 2×Cr of the core portion, satisfy a relationship R≤Cr.

4. The optical probe according to claim 1, wherein
the optical waveguide includes a core portion, and a cladding portion arranged on an outer periphery of the core portion, and
a refractive index distribution coefficient A^{1/2} of the optical waveguide, an inner diameter of the core portion 2×Cr, an optical axis refractive index n0 in an optical axis of the core portion, and an outer edge refractive index n1 in a region of the core portion, the region being adjacent to the cladding portion, satisfy a relationship
Cr={(n0²−n1²)/(A^{1/2}×n0)²}^{1/2}.

5. The optical probe according to claim 1, wherein
in a plane perpendicular to a normal direction of a vertex of the tip surface, a first radius of curvature R1 in a first direction, and a second radius of curvature R2 in a second direction perpendicular to the first direction are different.

6. The optical probe according to claim 1, wherein
a direction where the optical waveguide extends toward the base end surface obliquely intersects with the base end surface, and
a direction where the optical signal travels changes at a boundary between the optical waveguide and the base end surface.

7. The optical probe according to claim 6, wherein
the direction where the optical waveguide extends toward the base end surface intersects with the base end surface at approximately 45 degrees, and
the direction where the optical signal travels changes by approximately 90 degrees.

8. The optical probe according to claim 1, wherein an optical element for changing the direction where the optical signal travels is arranged on the base end surface.

9. The optical probe according to claim 8, wherein the optical element changes the direction where the optical signal travels by approximately 90 degrees.

10. An optical probe array configured by arranging a plurality of optical probes, wherein
an optical probe of the plurality of optical probes is configured to transmit an optical signal to, and receiving an optical signal from, an optical device,
the optical probe comprises:
a tip surface that is a convex curved surface and faces the optical device;
an optical waveguide that is a refractive index distribution type and has a first end part connected to the tip surface; and
a base end surface to which a second end part of the optical waveguide is connected.

11. A measurement system, comprising:
an optical probe for transmitting an optical signal to, and receiving an optical signal from, an optical device, comprising: a tip surface that is a convex curved surface and faces the optical device; an optical waveguide that is a refractive index distribution type and has a first end part connected to the tip surface; and a base end surface to which a second end part of the optical waveguide is connected;
a probe head that holds the optical probe; and
a moving device that moves the probe head in order to align the tip surface of the optical probe with the optical device.
